(19) United States
(12) Patent Application Publication
(10) Pub. No.: US 2026/0265158 A1
(43) Pub. Date: Sep. 10, 2026

(54) Granular Biocomposite Ecologic Fertiliser Based On Chicken Manure

(71) Applicant: Gradinaru Rares S.R.L., Comuna Dumbrava Rosie (RO)

(72) Inventor: Dan Gradinaru, Comuna Dumbrava Rosie (RO)

(73) Assignee: Gradinaru Rares S.R.L., Comuna Dumbrava Rosie (RO)

(21) Appl. No.: 19/163,985

(22) PCT Filed: Apr. 29, 2024
(86) PCT No.: PCT/RO2024/000012

§ 371 Date: Sep. 10, 2025

(30) Foreign Application Priority Data
May 9, 2023 (RO) 2023 00311

(51) Int. Cl. C05G 5/12; C05B 17/00

(52) U.S. Cl. CPC C05G 5/12; C05B 17/00

(57) ABSTRACT

The invention refers to a granular biocomposite fertilizer intended for soil and plant fertilization with granular fertilizers, obtained from compost made from chicken manure to which 17-23% lignite (preferably 25%) is added, with additional fertilizers added such as ammonium phosphate (phosphorus content expressed as phosphorus pentoxide P₂O₅) and potash rock (potassium content expressed as potassium oxide K₂O) intended for soil and plant fertilization with ecological granular fertilizers.

### BACKGROUND OF THE INVENTION

The invention refers to a granular biocomposite fertilizer obtained from chicken manure compost with added fertilizer components such as ammonium phosphate (phosphorus content expressed as phosphorus pentoxide P₂O₅) and potash rock (potassium content expressed as potassium oxide K₂O) intended for soil and plant fertilization with ecological granular fertilizers.

Chicken manure is a natural product rich in nutrients and it is characterized by a rapid mineralization and a low organic content. The multiple qualities of chicken manure are elements that recommend it to be used in agriculture as both fertilizer and as support and binding agent in the production process of granular organo-mineral fertilizers.

Laying hens' manure has the drawback that if it presents the risk of introducing pathogenic microbes in the soil, it can enter in a fermentation process during which it consumes the nitrogen in the soil.

To be used as fertilizer in producing granular fertilizers it is necessary that chicken manure be subjected to treatments so that these drawbacks may be eliminated by mineralizing the organic matter (animal proteins that make up chicken manure) that needs to be decomposed so as to obtain a great mineralization degree and a good biological stability. To this end, several technologies are available, among which composting is one of the most efficient.

Composting this type of waste with adding carbon-rich materials improves the compost quality and it has a stimulating action for plant development.

Several methods for producing organo-mineral fertilizers are known. According to U.S. Pat. No. 6,387,145B1 , the method deals with the production of a granular organo-mineral fertilizer with or without microelements (Zn, Mn, Cu, Co, Ma) and secondary elements (Ca, Mg, S), where the organic nitrogen comes from animal sources (blood, meat, or epithelium, boiled, dried, and ground), and granulation is carried out by atomization in a tower. U.S. Pat. No. 4,174,957 deals with a method of producing organo-mineral fertilizers where the fertilizing elements (urea, humus, or humic acids) are incorporated into the matrix of granules with a diameter of 1-10 mm formed from urea-formaldehyde resin foams.

For the purpose of obtaining a fertilizer for agriculture from chicken manure a method is known as RO 66935. Chicken manure are sent to a screw where, through squeezing, a reduction of their moisture content is achieved, followed by their drying and grinding. The disadvantage of this method is that it does not allow for complete aeration of the droppings, and as a result, their treatment is incomplete.

Another drawback of current organo-mineral fertilizers is that they do not contain easily accessible carbohydrates for plants, which can enhance the biological activity of bacteria and enzymes in both soil and plants.

Regarding the manufacturing technologies of organo-mineral fertilizers presented in patents, they do not include a method for introducing mineral components that minimizes the water content that must be removed after the granulation stage.

### SUMMARY OF THE INVENTION

The technical problem that the invention solves is that it creates a granular biocomposite organo-mineral fertilizer that contains an organic component derived from composted chicken manure and a mineral component (with phosphorus and potassium content) that enhances the biological activity of processes in both soil and plants.

The granular organo-mineral biocomposite fertilizer obtained according to the invention is a product with a homogeneous granulometric structure, brown in color, with a moisture content of 8-10% and a 44% (by mass percentage) compost content. This compost is obtained from a mixture consisting of 71%-83% (preferably 75%) chicken manure with a moisture content of 50%-65% (preferably 55%), to which 17-23% lignite (preferably 25%) is added, serving a dual role as an aeration (bulking) agent and a carbon source for the composting process. Additionally, as aeration (filler) agents, 17%-23% organic C source agents (lignite), 48% phosphoric rock, and 8% potassium salt are included.

An example of realizing the invention is provided connected to FIG. 1.

### BRIEF DESCRIPTION OF THE DRAWINGS

FIG. 1 is a flow chart illustrating the steps of a technological process.

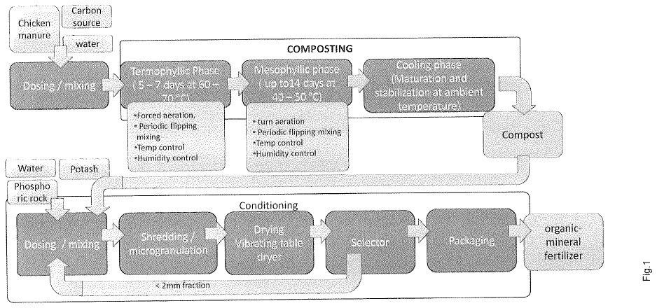

### DETAILED DESCRIPTION OF THE INVENTION

The first stage of the fertilizer production process involves the following steps:

The preliminary mixing phase of chicken manure with 70% moisture with carbon-rich aeration agents with 20% moisture, in a 10:6 ratio, ensures a C/N ratio of 23:1. To maintain the initial moisture level of 55%, water is added.

In the first stage, the input material is created by dosing a mixture consisting of 71%-83% Chicken manure with 50%-70% moisture, to which aeration agents (fillers) comprising 17%-23% organic C source (lignite) are added.

The resulting mixture is introduced into a reactor with aeration channels at the bottom, where forced aeration is carried out with a fan. Mixing is achieved by periodic turning or by moving the static pile from one channel to another. The mixture has 60-65% moisture and the temperature is maintained at 60-70° C. to promote the development of microbial communities. During the process, forced aeration is conducted to control both the temperature and moisture of the mixture. After 5-6 days, the thermophilic phase of the process is completed, the temperature is reduced to 40-50° C., and aeration is continued by periodically turning the mixture while monitoring the temperature and moisture.

After 22-24 days, the static pile is transported to a waiting hall, where the compost temperature is checked. If the temperature remains constant or it decreases, the composting process is considered complete.

The second stage of the production process involves the following:

The dosing of fertilizer components to obtain a granular organo-mineral biocomposite fertilizer, where the previously obtained compost is mixed in a proportion of 44% fertilizing compost, 48% phosphoric rock, and 8% potassium salt, along with water.

The mixture is introduced into the complex mixing/granulation installation for the purpose of mixing, crushing, and forming pre-granules with a size of 1-2 mm, resulting in the granular biocomposite fertilizer.

The biocomposite fertilizer obtained has the following compositional characteristics: the nitrogen content is below 1%; the phosphorus content (expressed as P₂O₅) a minimum of 13.5-14.5%; the potassium content (expressed as K₂O) is 5-6%.

The next step involves the granulation process to obtain granules of granular organo-mineral fertilizer with particle sizes of 2-5 mm, which are then subjected to a drying process at a drying temperature of 100° C. on a vibrating table, then they are selected, and packaged.

According to the invention, the production of granular organo-mineral biocomposite fertilizer offers the following advantages:
High productivity due to process continuity;
Simultaneous application of fertilizer with crop sowing significantly reduces fertilizer consumption;
Large-scale processing of bird excrement waste;
Organic matter improves soil structure, resulting in a crumb-like structure; and
Organic matter enhances water retention and improves soil fertility.

1-3. (canceled)

4. A granular, environmentally friendly biocomposite fertilizer based on bird manure waste, with uniform brown particle size structure, the fertilizer comprising a homogeneous mixture of 44% (mass percentage) compost, 48% (mass percentage) phosphate rock and 8% (mass percentage) potassium salt, after which the mixture obtained is shredded and pre-granulated, followed by the transformation into granules of the fertilizer.

5. The biocomposite fertilizer according to claim 4, wherein the compost is obtained from 77% to 83% poultry manure waste with a humidity of 50% to 65%, to which is added organic carbon agents in a range from 17% to 23% wherein the organic carbon agents function as a loosening agent (filler) and a source of organic carbon.

6. The biocomposite fertilizer according to claim 4, wherein the fertilizer contains less than 1% nitrogen, a minimum of 13.4 to 14.5% phosphorus expressed as P₂O₅ and 5 to 6% potassium expressed as K₂O.

7. The biocomposite fertilizer according to claim 4, wherein the fertilizer includes 17 to 23 % organic carbon, which functions in a dual role as a loosening agent (filler), and as a source of organic carbon (C).

8. The biocomposite fertilizer in accordance with claim 4, wherein the compost is 77% poultry manure and 55% humidity.

9. A method of forming a biocomposite fertilizer comprising:
a preliminary stage of mixing poultry manure with carbon-and water-rich loosening agents;
a compositing stage of forced aeration of the mixture obtained by ventilation, periodic overturning or moving of the mixture for the development of microbial communities until the mixture reaches a humidity of 50 to 65% and a temperature of 60 to 70 C°, a stage that lasts for 5 to 6 days;
measuring a reduction of the temperature of the mixture to between 40 to 50 C° and continuing aeration by overturning the mixture for 22 to 24 days, wherein the composting process is completed when the mixture temperature is constant;
a conditioning step of dosing and mixing the fertilizer compost with phosphate rock, potassium salt and water until pre-granules with a size of 1 to 2 mm are formed; and
a granulation step for obtaining fertilizer granules with a particle size of 2 to 5 mm, comprising drying the granules at a temperature of 100 C°.

10. The method in accordance with claim 9, further comprising selecting and packaging the fertilizer.

11. A biocomposite fertilizer obtained from the process of claim 9.
